(19) United States
(12) Patent Application Publication
(10) Pub. No.: US 2019/0025622 A1
(43) Pub. Date: Jan. 24, 2019

(54) LIQUID CRYSTAL DISPLAY APPARATUS AND BORDER DESIGN THEREOF

(71) Applicants: HKC Corporation Limited, Shenzhen City, Guangdong (CN); Chongqing HKC Optoelectronics Technology Corporation Limited, Chongqing (CN)

(72) Inventor: Yu-Jen CHEN, Chongqing (CN)

(21) Appl. No.: 15/537,183

(22) PCT Filed: Mar. 1, 2017
(86) PCT No.: PCT/CN2017/075288

§ 371 Date: Jun. 16, 2017

(30) Foreign Application Priority Data
Dec. 30, 2016 (CN) 201611258491.5

(51) Int. Cl. G02F 1/1362; G02F 1/1333; G02F 1/1339; G02F 1/1335; G02F 1/1368

(52) U.S. Cl. CPC G02F 1/1362; G02F 1/133345; G02F 1/13394; G02F 2001/136222; G02F 1/1368; G02F 2001/133357; G02F 1/133512

(57) ABSTRACT

This application relates to a liquid crystal display apparatus and a border design thereof. A liquid crystal display panel includes: a second substrate, having a display area and a border area, where the border area is located on an edge of the second substrate and surrounds the display area; a color filter layer, located on the display area of the second substrate, where the color filter layer has a first thickness; and a planarization layer, located on the border area of the second substrate and surrounding the display area, where the planarization layer has a second thickness, and the second thickness is the same as the first thickness, so that the planarization layer is leveled with the color filter layer, and the planarization layer is connected to the color filter layer to form a same plane. The second thickness is the same as the first thickness.

### BACKGROUND

### Technical Field

This application relates to a liquid crystal display panel, and in particular, to a color filter on TFT (COT)-type liquid crystal display panel and a border design thereof.

### Related Art

A liquid crystal display having a favorable effect on displaying a motion image has high contrast, and is aggressively used as a TV or monitor. The liquid crystal display (LCD) displays an image by using optical anisotropy and polarization of liquid crystals.

A liquid crystal panel is used as a main member of an LCD. The liquid crystal panel includes a first substrate and a second substrate facing each other, and a liquid crystal layer is disposed between the first substrate and the second substrate. A transmittance difference is implemented by changing an alignment direction of a liquid crystal molecule according to an electric field generated in the liquid crystal panel.

Recently, due to an advantage of increasing an aperture ratio by minimizing an alignment margin between a first substrate and a second substrate, a color filter on a COT-type liquid, crystal display using a thin film transistor (TFT) and a color filter that are formed on the first substrate is used.

A COT-type liquid crystal display in the prior art includes: a first substrate, where a TFT, a color filter, a pixel electrode, and a first alignment layer are formed on the first substrate; a second substrate, where the second substrate is connected to the first substrate by using a sealant, and a common electrode and a second alignment layer are formed on the second substrate; a liquid crystal layer, where the liquid crystal layer is located between the first substrate and the second substrate; and a black columnar spacer, where the black columnar spacer is configured to keep a gap between the first substrate and the second substrate.

Currently, according to a screen process of a COT technology, an offset is likely to be caused due to a topographical difference between a display area and an border area of a liquid crystal display panel. Consequently liquid crystals are not easily diffused, and vacuum bubbles are generated along the edges in a cell process. Therefore, how to avoid vacuum bubbles on the edges has always been a subject for the COT process.

### SUMMARY

To resolve the foregoing technical problem, an objective of this application is to provide a liquid crystal display panel, and in particular, this application relates to a COT-type liquid crystal display panel, so as to resolve a problem that vacuum bubbles are generated along the edges in a cell process because a large offset between a display area and an border area causes poor diffusion of liquid crystals, and to make a substrate smaller by reducing a use area of a circuit region in the border area.

The objective of this application is achieved and the technical problem of this application is resolved by using the following technical solution.

According to this application, a liquid crystal display panel is provided, comprising: a first substrate; a second substrate, having a display area and a border area, where the border area is located on an edge of the second substrate and surrounds the display area; a color filter layer, located on the display area of the second substrate, where the color filter layer has a first thickness; and a planarization layer, located on the border area of the second substrate and surrounding the color filter layer, where the planarization layer has a second thickness, and the second thickness is the same as the first thickness, so that the planarization layer is leveled with, the color filter layer, and the planarization layer is connected to the color filter layer to form a same plane.

The objective of this application may also be further achieved and the technical problem of this application may also be further resolved by taking the following technical measures.

In an embodiment of this application, the planarization layer comprises a red color filter layer, a green color filter layer, and a blue color filter layer.

In an embodiment of this application, the planarization layer is a red color filter layer, a green color filter layer, or a blue color filter layer.

In an embodiment of this application, the planarization layer is a white color filter layer.

In an embodiment of this application, the planarization layer is a polymer material layer.

Another objective of this application is to provide a liquid crystal display apparatus, comprising: a first substrate; a second substrate; and a liquid crystal layer, located between the first substrate and the second substrate, where the second substrate has a color filter layer, a planarization layer, a display area, and a border area, the border area is located on an edge of the second substrate and surrounds the display area, the color filter layer is located on the display area of the second substrate, the color filter layer has a first thickness, and the planarization layer is located the on the border area of the second substrate and surrounds the color filter layer; and the planarization layer has a second thickness, and the second thickness is the same as the first thickness, so that the planarization layer is leveled with the color filter layer, and the planarization layer is connected to the color filter layer to form a same plane.

The another objective of this application may also be further achieved and the technical problem of this application may also be further resolved by taking the following technical measures.

In an embodiment of this application, the planarization layer comprises a red color filter layer, a green color filter layer, and a blue color filter layer.

In an embodiment of this application, the planarization layer is a red color filter layer, a green color filter layer, or a blue color filter layer.

In an embodiment of this application, the planarization layer is a white color filter layer.

In an embodiment of this application, the planarization layer is a polymer material layer.

In this application, the planarization layer has the second thickness, and the second thickness is the same as the first thickness, so that the planarization layer is leveled with the color filter layer, and the planarization layer is connected to the color filter layer to form a same plane, so as to resolve a problem that vacuum bubbles are generated along the edges in a cell process because a large offset between the display area and the border area causes poor diffusion of liquid crystals, and to make a substrate smaller by reducing a use area of a circuit region in the border area.

Further, in this application, the color filter layer and the planarization layer have the same material to effectively reduce costs and improve a cell yield.

### BRIEF DESCRIPTION OF THE DRAWINGS

FIG. 1a is a schematic diagram of a screen process of an exemplary COT technology according to this application;

FIG. 1b is a schematic diagram of a vacuum bubble generation location in a screen process of an exemplary COT technology according to this application;

FIG. 2a is a schematic diagram of a planarization layer of a liquid crystal display panel according to an embodiment of this application;

FIG. 2b is a schematic diagram of an border area and a display area of a liquid crystal display panel according to an embodiment of this application;

FIG. 2c is a schematic diagram of a gate circuit of a liquid crystal display panel according to an embodiment of this application;

FIG. 2d is a schematic diagram of covering a gate circuit by a planarization layer of a liquid crystal display panel according to an embodiment of this application;

FIG. 3a is a schematic diagram of a planarization layer of a liquid crystal display panel being a three-color color filter layer according to an embodiment of this application;

FIG. 3b is a schematic diagram of a planarization layer of a liquid crystal display panel being a single-color color filter layer according to an embodiment of this application; and

FIG. 3c is a schematic diagram of a planarization layer of a liquid crystal display panel being a white color filter layer according, to an embodiment of this application.

### DETAILED DESCRIPTION

The following embodiments are described with reference to the accompanying drawings, which are used to exemplify specific embodiments for implementation of this application. Terms about directions mentioned in this application, such, as “on”, “below”, “front”, “back”, “left”, “right”, “in”, “out”, and “side surface”, merely refer to directions of the accompanying drawings. Therefore, the used terms about directions are used to describe and understand this application, and are not intended to limit this application.

The accompanying drawings and the description are considered to be essentially exemplary, rather than limitative. In figures, units with similar structures are represented by using a same reference number. In addition, for understanding and ease of description, a size and a thickness of each component shown in the accompanying drawings are arbitrarily shown, but this application is not limited thereto.

In the accompanying drawings, for clarity, thicknesses of a layer, a firm, a panel, an area, and the like are enlarged. In the accompanying drawings, for understanding and ease of description, thicknesses of some layers and areas are enlarged. It should be understood that when a component such as a layer, a film, an area, or a substrate is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located on or below a target component, but does not mean that the component needs to be located on top of a gravity direction.

To further describe the technical means adopted in this application to achieve the preset invention objective and effects thereof, specific implementations, structures, features, and effects of a liquid crystal display apparatus and a border design thereof provided according to this application are described below in detail with reference to the drawings and preferred embodiments.

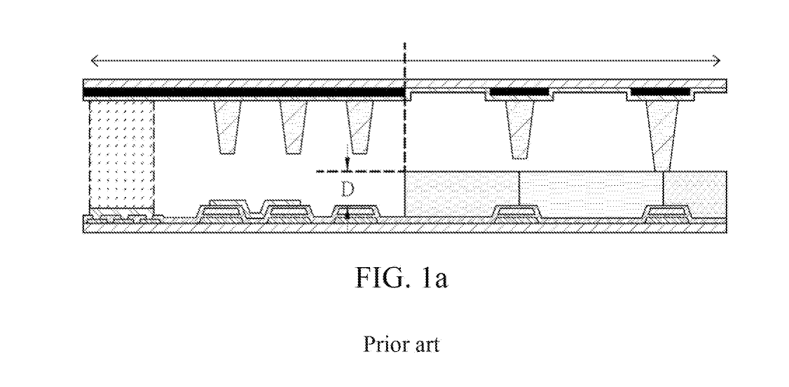

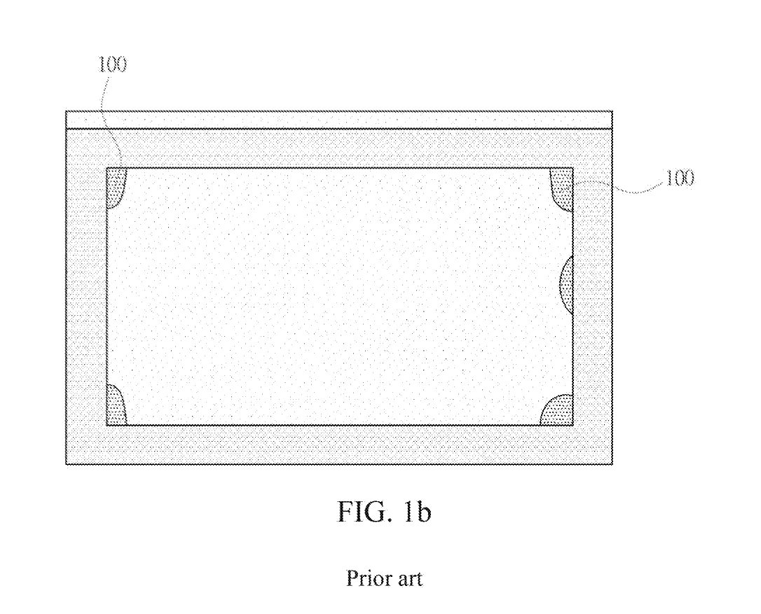

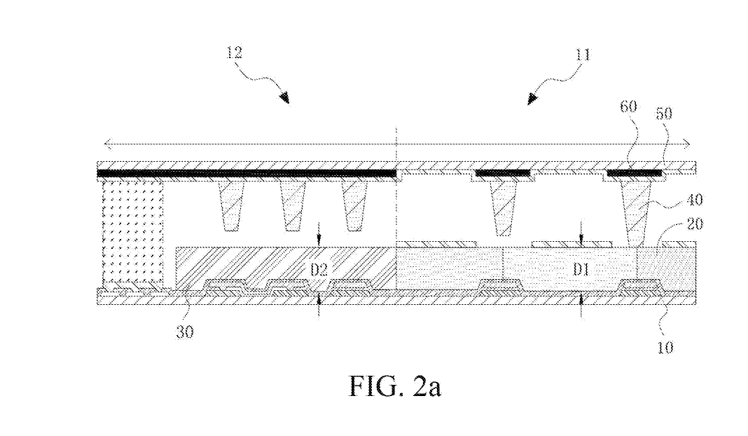

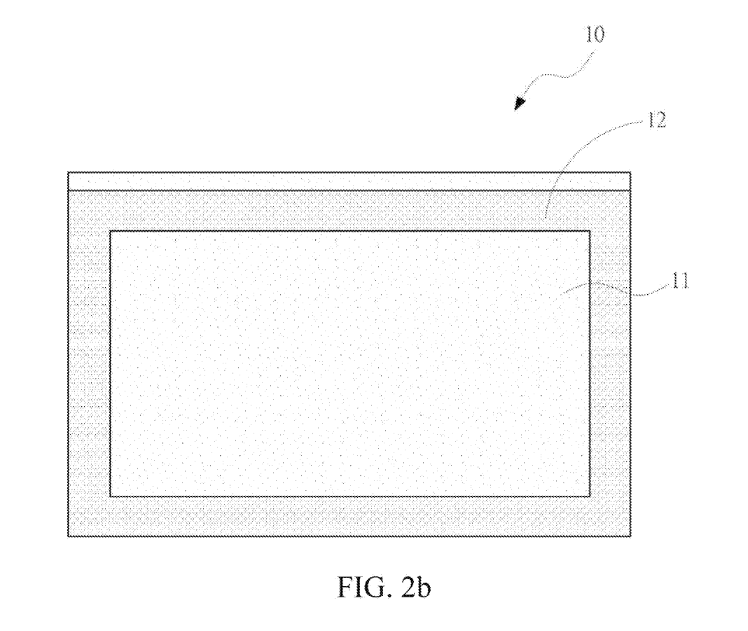

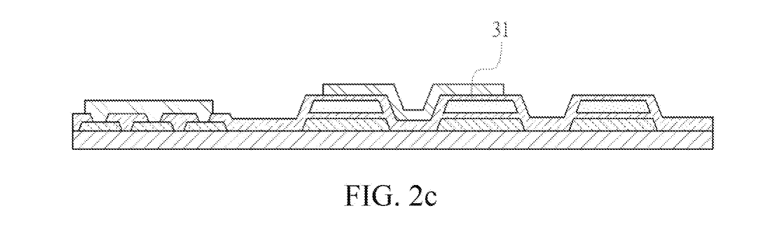

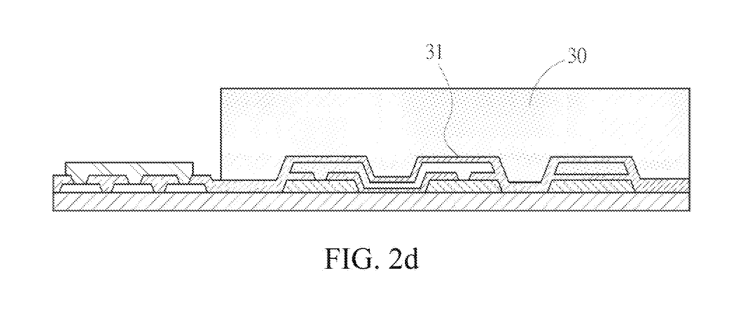

Referring to FIG. 1a and FIG. 1b, FIG. 1a is a schematic diagram of a screen process of an exemplary COT technology according to this application, and FIG. 1b is a schematic diagram of a vacuum bubble generation location in a screen process of an exemplary COT technology according to this application. According to the screen process of the COT technology, an offset D is likely to be caused due to a topographical difference between a display area and an border area of a liquid crystal display panel. Consequently, liquid crystals are not easily diffused, and vacuum bubbles 100 are generated along the edges in a cell process. Referring to FIG. 2a and FIG. 2b, FIG. 2a is a schematic diagram of a planarization layer of a liquid crystal display panel according to an embodiment of this application, and FIG. 2b is a schematic diagram of an border area and a display area of a liquid crystal display panel according to an embodiment of this application. The liquid crystal display panel in this application can include: a first substrate, a second substrate 10, having a display area 11 and a border area 12, wherein the border area 12 is located on an edge of the second substrate 10 and surrounds the display area 11; a color filter layer 20, located on the display area 11 of the second substrate 10, where the color filter layer 20 has a first thickness D1; and a planarization layer 30, located on the border area 12 of the second substrate 10 and surrounding the color filter layer 20. The planarization layer 30 can have a second thickness D2, and the second thickness D2 is the same as the first thickness D1, so that the planarization layer 30 is leveled with the color filter layer 20, and the planarization layer 30 is connected to the color filter layer 20 to form a same plane. Further, a support spacer 40 is located on the color filter layer 20, the first substrate 50 is located on the support spacer 40, and the support spacer 40 is configured to support the first substrate 50.

Further, a black matrix 60 may be disposed between the first substrate 50 and the support spacer 40.

Further, referring, to FIG. 2c and FIG. 2d, FIG. 2c is a schematic diagram of a gate circuit of a liquid crystal display panel according to an embodiment of this application, and FIG. 2d is a schematic diagram of covering a gate circuit by a planarization layer of a liquid crystal display panel according to an embodiment of this application. In an embodiment of this application, a gate dielectric layer 31 in the border area uses an extra photo mask to define a through hole a through hole in the border area for a gate dielectric layer 31 may be defined by using a photo mask. The through hole in the border area can function as a bridge for signals on a circuit. Therefore, the planarization layer 30 can directly cover the gate dielectric layer 31, and no through hole design is required on the planarization layer 30.

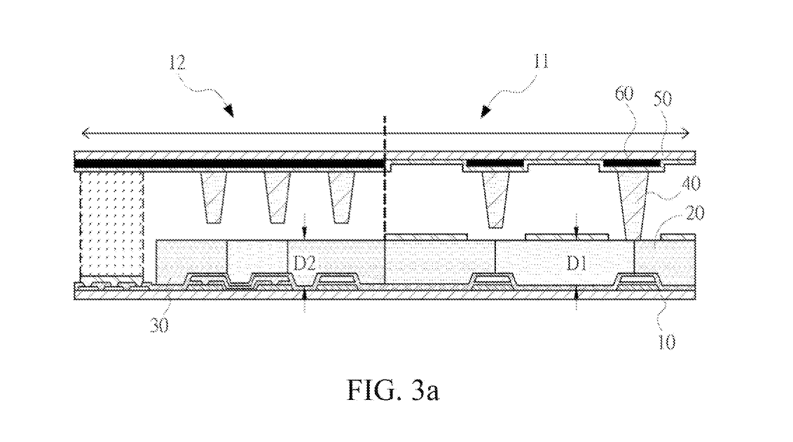

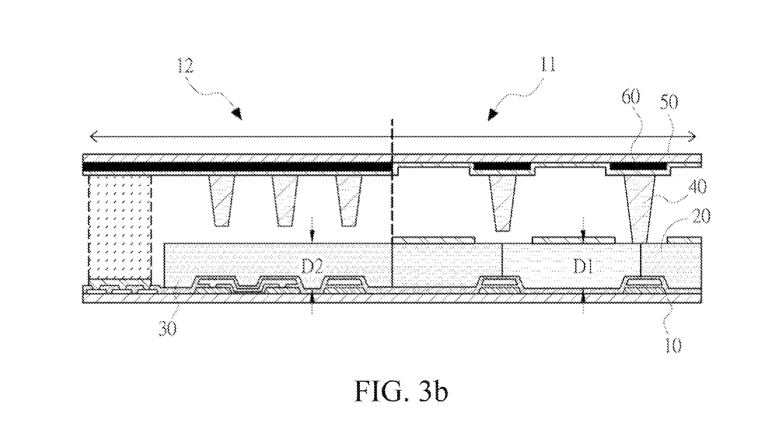

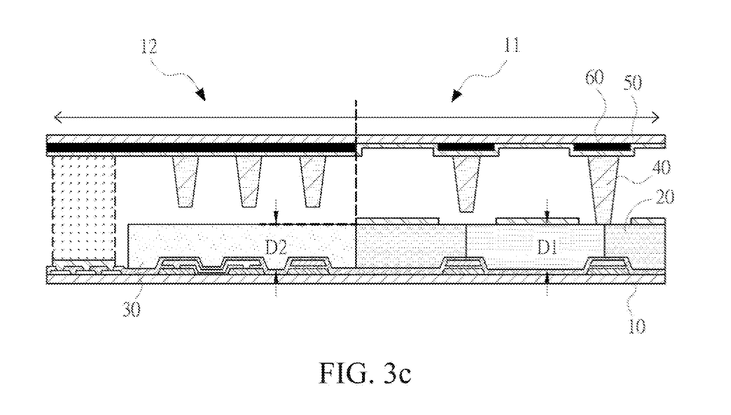

Furthermore, referring to FIG. 3a, FIG. 3a is a schematic diagram of a planarization layer of a liquid crystal display panel being a three-color color filter layer according to an embodiment of this application. In an embodiment of this application, the planarization layer 30 includes a red color filter layer, a green color filter layer, and a blue color filter layer. That is, three color filter layers of different colors coexist.

In addition, referring to FIG. 3b, FIG. 3b is a schematic diagram of a planarization layer of a liquid crystal display panel being a single-color color filter layer according to an embodiment of this application. In an embodiment of this application, the planarization layer 30 is a red color filter layer, a green color filter layer, or a blue color filter layer. That is, the planarization layer 30 is merely a single-color color filter layer.

Further, referring to FIG. 3c, FIG. 3c is a schematic diagram of a planarization layer of a liquid crystal display panel being a white color filter layer according to an embodiment of this application. In an embodiment of this application the planarization layer 30 is a white color filter layer.

In an embodiment of this application, the planarization layer 30 is a polymer material layer.

In this application, the planarization layer has the second thickness, and the second thickness is the same as the first thickness, so that the planarization layer is leveled with the color filter layer, and the planarization layer is connected to the color filter layer to form a same plane, so as to resolve a problem that vacuum bubbles are generated along the edges in a cell process because a large offset between the display area and the border area causes poor diffusion of liquid crystals, and to make a substrate smaller by effectively reducing a use area of a circuit design end and improving a cell yield.

Further, the color filter layer and the planarization layer have the same material, to effectively reduce costs and improve a cell yield.

Further, this application provides a liquid crystal display apparatus, including: a first substrate 50; a second substrate 10; and a liquid crystal layer, located between the first substrate 50 and the second substrate 10. Still referring to FIG. 2a and FIG. 2b, FIG. 2a is a schematic diagram of a planarization layer of a liquid crystal display panel according to an embodiment of this application, and FIG. 2b is a schematic diagram of an border area and a display area of a liquid crystal display panel according to an embodiment of this application. The second substrate has a color filter layer 20, a planarization layer 30, a display area 11, and a border area 12. The border area 12 is located on an edge of the second substrate 10 and surrounds the display area 11. The color filter layer 20 is located on the display area 11 of the second substrate 10. The color filter layer 20 has a first thickness D1. The planarization layer 30 is located the on the border area 12 of the second substrate 10 and surrounds the color filter layer 20. The planarization layer 30 has a second thickness D2, and the second thickness D2 is the same as the first thickness D1, so that the planarization layer 30 is leveled with the color filter layer 20, and the planarization layer 30 is connected to the color filter layer 20 to form a same plane. Further, a support spacer 40 is located on the color filter layer 20 the first substrate 50 is located on the support spacer 40, and the support spacer 40 is configured to support the first substrate 50. Further, a black matrix 60 is disposed between the first substrate 50 and the support spacer 40.

Further, still referring to FIG. 2c and FIG. 2d, FIG. 2c is a schematic diagram of a gate circuit of a liquid crystal display panel according to an embodiment of this application, and FIG. 2d is a schematic diagram of covering a gate circuit by a planarization layer of a liquid crystal display panel according to an embodiment of this application. In an embodiment of this application, a through hole in the border area for a gate dielectric layer 31 may be defined by using a photo mask and the through hole in the border area can function as a bridge for signals on a circuit. Therefore, the planarization layer 30 can directly cover the gate dielectric layer 31, and no through hole design is required on the planarization layer 30.

Next, still referring to FIG. 3a, FIG. 3a is a schematic diagram of a planarization layer of a liquid crystal display panel being a three-color color filter layer according to an embodiment of this application. In an embodiment of this application, the planarization layer 30 includes a red color filter layer, a green color filter layer, and a blue color filter layer. That is, three color filter layers of different colors coexist.

In addition, still referring to FIG. 3b, FIG. 3b is a schematic diagram of a planarization layer of a liquid crystal display panel being a single-color color filter layer according to an embodiment of this application. In an embodiment of this application, the planarization layer 30 is a red color filter layer, a green color filter layer, or a blue color filter layer. That is, the planarization layer 30 is merely a single-color color filter layer.

Further, still referring to FIG. 3c, FIG. 3c is a schematic diagram of a planarization layer of a liquid crystal display panel being a white color filter layer according to an embodiment of this application. In an embodiment of this application, the planarization layer 30 is a white color filter layer.

In an embodiment of this application, the planarization layer 30 is a polymer material layer.

In this application, the planarization layer has the second thickness, and the second thickness is the same as the first thickness, so that the planarization layer is leveled with the color filter layer, and the planarization layer is connected to the color filter layer to form a same plane, so as to resolve a problem that vacuum bubbles are generated along the edges in a cell process because a large offset between the display area and the border area causes poor diffusion of liquid crystals, and to make a substrate smaller by effectively reducing a use area of a circuit design end and improving a cell yield.

Further, in this application, the color filter layer and the planarization layer have the same material, to effectively reduce costs and improve a cell yield.

Terms such as “in some embodiments” and “in various embodiments” are repeatedly used. Usually, the terms do not refer to a same embodiment; but they may also refer to a same embodiment. Words such as “comprise”, “have”, “include” are synonyms, unless other meanings are indicated in the context.

The foregoing descriptions are merely preferred embodiments of this application, and are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change or modification made to the foregoing embodiments according to the technical essence of this application without departing from the content of the technical solutions of this application shall fall within the scope of the technical solutions of this application.

What is claimed is:

1. A liquid crystal display panel, comprising:
a first substrate;
a second substrate, having a display area and a border area, wherein the border area is located on an edge of the second substrate and surrounds the display area;
a color filter layer, located on the display area of the second substrate, wherein the color filter layer has a first thickness; and
a planarization layer, located on the border area of the second substrate and surrounding the color filter layer, wherein
the planarization layer has a second thickness, and the second thickness is the same as the first thickness, so that the planarization layer is leveled with the color filter layer, and the planarization layer is connected to the color filter layer to form a same plane.

2. The liquid crystal display panel according to claim 1, wherein the planarization layer comprises a red color filter layer, a green color filter layer, and a blue color filter layer.

3. The liquid crystal display panel according to claim 1, wherein the planarization layer is a red color filter layer, a green color filter layer, or a blue color filter layer.

4. The liquid crystal display panel according to claim 1, wherein the planarization layer is a white color filter layer.

5. The liquid crystal display panel according to claim 1, wherein the planarization layer is a polymer material layer.

6. The liquid crystal display panel according to claim 1, further comprising a support spacer located on the color filter layer, wherein the first substrate is located on the support spacer, and the support spacer is configured to support the first substrate.

7. The liquid crystal display panel according to claim 6, wherein a black matrix is disposed between the first substrate and the support spacer.

8. The liquid crystal display panel according to claim 1, wherein the planarization layer is formed without a through hole.

9. The liquid crystal display panel according to claim 1, wherein the color filter layer and the planarization layer have the same material.

10. A liquid crystal display panel, comprising:
a first substrate;
a second substrate, having a display area and a border area, wherein the border area is located on an edge of the second substrate and surrounds the display area;
a color filter layer, located on the display area of the second substrate, wherein the color filter layer has a first thickness; and
a planarization layer, located on the border area of the second substrate and surrounding the color filter layer, wherein planarization layer has no through hole;
a support spacer is located on the color filter layer, the first substrate is located on the support spacer, and the support spacer is configured to support the first substrate;
the planarization layer has a second thickness, and the second thickness is the same as the first thickness, so that the planarization layer is leveled with the color filter layer, and the planarization layer is connected to the color filter layer to form a same plane;
the planarization layer comprises a red color filter layer, a green color filter layer, and a blue color filter layer, or is a single-color color filter layer or a white color filter layer; and
a black matrix is disposed between the first substrate and the support spacer.

11. A liquid crystal display apparatus, comprising:
a first substrate;
a second substrate; and
a liquid crystal layer, located between the first substrate and the second substrate, wherein
the second substrate has a color filter layer, a planarization layer, a display area, and a border area, the border area is located on an edge of the second substrate and surrounds the display area, the color filter layer is located on the display area of the second substrate, the color filter layer has a first thickness, and the planarization layer is located the on the border area of the second substrate and surrounds the display area;
the planarization layer has a second thickness, and the second thickness is the same as the first thickness, so that the planarization layer is leveled with the color filter layer, and the planarization layer is connected to the color filter layer to form a same plane; and
the liquid crystal display apparatus further comprises a gate dielectric layer located on the second substrate, and the planarization layer covers the gate dielectric layer.

12. The liquid crystal display apparatus according to claim 11, wherein the planarization layer comprises a red color filter layer, a green color filter layer, and a blue color filter layer.

13. The liquid crystal display apparatus according to claim 11, wherein the planarization layer is a red color filter layer, a green color filter layer, or a blue color filter layer.

14. The liquid crystal display apparatus according to claim 11, wherein the planarization layer is a white color filter layer, and the planarization layer is a polymer material layer.

15. The liquid crystal display apparatus according to claim 11, further comprising a support spacer located on the color filter layer, wherein the first substrate is located on the support spacer, the support spacer is configured to support the first substrate, and a black matrix is disposed between the first substrate and the support spacer.

16. The liquid crystal display apparatus according to claim 11, wherein the planarization layer is formed without a through hole.

17. The liquid crystal display apparatus according to claim 11, wherein the color filter layer and the planarization layer have the same material.
